(19) United States
(12) Patent Application Publication
(10) Pub. No.: US 2012/0055995 A1
(43) Pub. Date: Mar. 8, 2012

(54) PRODUCT CODE READER AND PRODUCT CODE READING METHOD

(75) Inventor: Jun Miyazaki, Aichi (JP)

(73) Assignee: TOSHIBA TEC KABUSHIKI KAISHA, Tokyo (JP)

(21) Appl. No.: 13/220,911

(22) Filed: Aug. 30, 2011

(30) Foreign Application Priority Data
Sep. 2, 2010 (JP) 2010-197075

(51) Int. Cl. G06K 7/14

(52) U.S. Cl. 235/454

(57) ABSTRACT

There is disclosed a product code reader including: an image importing section which imports an image imaged by an imaging section; a code symbol detecting section which detects a code symbol affixed to a product, from a product image imported by the image importing section; a code reading section which reads code information retained in the code symbol, from the code symbol detected by the code symbol detecting section; and a specific item detecting section which detects a predetermined article attached to the product as a specific item, from the product image imported by the image importing section.

### CROSS-REFERENCE TO RELATED APPLICATION

This application is based upon and claims benefit of priority from Japanese Patent Application No. 2010-197075 filed on Sep. 2, 2010, the entire contents of which are incorporated herein by reference.

### FIELD

Embodiments described herein relate to a product code reader and a product code reading method.

### BACKGROUND

In the related art, in retail stores such as a supermarket, a predetermined article (hereinafter, referred to as a specific item) is attached to a commercial product, for efficient product management. As an example of the specific item, a security tag attached for security such as anti-theft, a hanger or the like attached for display of clothes or the like, is used. Such a specific item is managed so that a response measure is provided according to the specific item, for example, so that the specific item is removed from a product at the time of settlement for the product.

Further, with regard to reading of a barcode affixed to a product, there is known a technique in which a barcode portion affixed to a product is imaged using an image sensor such as a CCD (Charge Coupled Device) and a product code is read from an imaged image.

However, since the specific item detection in the related art as described above is carried out by a visual contact of an operator or the like, an oversight may occur.

### DESCRIPTION OF THE DRAWINGS

FIG. 1 is a perspective view schematically illustrating a configuration of a checkout system according to an embodiment.

FIG. 2 is a block diagram illustrating a configuration of a POS terminal and a code reader according to an embodiment.

FIG. 3 is a diagram schematically illustrating an example of a template file.

FIG. 4 is a diagram illustrating an example of a specific item.

FIG. 5 is a diagram illustrating another example of a specific item.

FIG. 6 is a flowchart illustrating a routine of an information output process performed by a code reader.

FIG. 7 is a diagram illustrating an example of a screen displayed on an operator display of a code reader.

FIG. 8 is a flowchart illustrating another routine of an information output process performed by a code reader.

FIG. 9 is a block diagram illustrating a configuration of a product code reader according to a modified example.

FIG. 10 is a diagram schematically illustrating an example of a product template file.

FIG. 11 is a flowchart illustrating a routine of an information output process performed by a product code reader according to a modified example.

### DETAILED DESCRIPTION

According to an embodiment, there is provided a product code reader including: an image importing section; a code symbol detecting section; a code reading section; and a specific item detecting section. The image importing section imports an image imaged by an imaging section. The code symbol detecting section detects a code symbol affixed to a product, from a product image imported by the image importing section. The code reading section reads code information retained in the code symbol, from the code symbol detected by the code symbol detecting section. The specific item detecting section detects a predetermined article attached to the product as a specific item, from the product image imported by the image importing section.

Hereinafter, a product code reader and a program according to an embodiment will be described using a checkout system as an example. In this embodiment, a checkout system introduced to a store such as a restaurant or a supermarket will be described as an example.

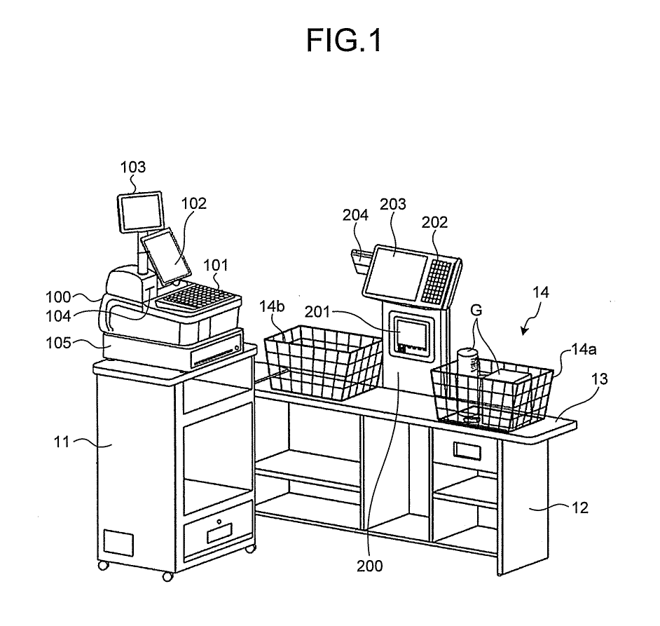

FIG. 1 is a perspective view schematically illustrating a configuration of a checkout system according to a first embodiment. As shown in FIG. 1, the checkout system includes a POS (Point Of Sales) terminal 100 and a product code reader 200.

The POS terminal 100 is a product information processing device which performs sale registration of products purchased by a customer, and is mounted on a checkout table 11. The POS terminal 100 includes a keyboard 101, an operator display 102, a customer display 103, a printer 104, and a drawer 105. The respective sections included in the POS terminal 100 will be described later.

Further, a counter table 12 of a transversely long table shape is disposed to form an L shape with respect to the checkout table 11. On an upper surface of the counter table 12, a product placing surface 13 is formed. The product code reader 200 is mounted on the product placing surface 13 and is connected with the POS terminal 100 for communication in a wired or wireless manner.

The product code reader 200 reads a code symbol affixed to a product and outputs a product code retained in the code symbol to the POS terminal 100. As shown in FIG. 1, the product code reader 200 includes a reading window 201, a keyboard 202, an operator display 203, and a customer display 204. The respective sections included in the product code reader 200 will be described later.

A shopping basket 14 which accommodates a product G to which a code label which will be described later is affixed is placed on the product placing surface 13. The shopping basket 14 includes a first shopping basket 14a carried by a customer and a second shopping basket 14b placed on a position where the product code reader 200 is interposed between the first shopping basket 14a and the second shopping basket 14b.

In the first shopping basket 14a carried by the customer, the product G handled in one transaction is accommodated. To the product G is affixed a code label indicating a code symbol such as a barcode or a two-dimensional code. The product code relating to the product G is retained in the code symbol in a coded state. The product code is a code allocated to each product for specifying the product G, and the JAN (Japan Article Number) code is an example thereof. The JAN code is internationally referred to as the EAN code (European Article Number). The JAN code is a common product code which is compatible with the UPC (Universal Product Code) in the USA and Canada.

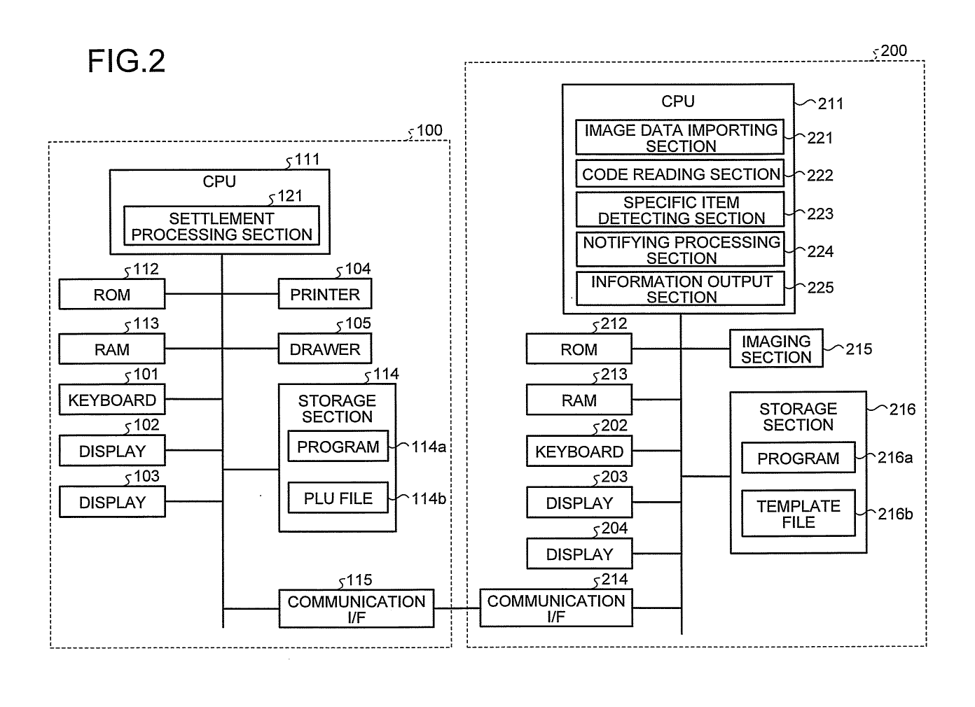

The product G in the first shopping basket 14a is moved to the second shopping basket 14b by an operator who operates the product code reader 200. In this movement process, the product is directed to the reading window 201 of the product code reader 200. At this time, an imaging section 215 (see FIG. 2) which will be described later, installed in the reading window 201, images the code label affixed to the product G.

The product code reader 200 detects a code symbol from an image of the product G imaged by the imaging section 215, and then reads the product code relating to the product G from the code symbol. In this embodiment, an example in which a barcode is used as the code symbol is described. However, the embodiment is not limited thereto, and may use a two-dimensional code.

Further, the product code reader 200 determines whether a specific article (hereinafter, referred to as a specific item) is included in image data imaged by the imaging section 215. Here, the specific item is an article attached to the product G for management of the corresponding product G. As an example of the specific item, there is a security tag attached for security such as anti-theft, a hanger or the like attached for display of clothes, or the like. The security tag reacts to, for example, radio waves of a specific frequency, and emits a predetermined signal, sound or light.

If the specific item is detected from the image data, the product code reader 200 notifies the operator of the product code reader 200 of the fact that the specific item is attached to the product G, so as to prompt the operator to remove the specific item from the product G.

Hereinafter, a configuration of the checkout system will be described. FIG. 2 is a block diagram illustrating a configuration of the POS terminal 100 and the product code reader 200.

Firstly, the configuration of the POS terminal 100 will be described. The POS terminal 100 includes a CPU (Central Processing Unit) 111 which is a microprocessor which performs information processing, a ROM (Read Only Memory) 112 and a RAM (Random Access Memory) 113.

The CPU 111 causes a variety of programs stored in the ROM 112 or a storage section 114 which will be described later to be executed, to thereby overall control the POS terminal 100. The ROM 112 stores a program for performing a basic operation. The RAM 113 is a main storage device of the POS terminal 100 and functions as a work area of the CPU 111.

Further, the keyboard 101, the display 102, the display 103, the printer 104 and the drawer 105, as described above, are connected to the CPU 111, through a variety of input/output circuits (not shown).

The keyboard 101 is an input device which notifies the CPU 111 of information about keys (hereinafter, referred to as key information) input from the operator who operates the POS terminal 100. A variety of operation keys such as a numerical keypad for inputting numerals or operators, or “sum” key necessary for settlement for a product price is provided in the keyboard 101.

The display 102 and the display 103 include a display device such as an LCD (Liquid Crystal Display), and display a variety of information such as a name of the product or a price thereof on the basis of an instruction of the CPU 111. Here, the display 102 is a display for an operator who operates the POS terminal 100, and its display surface is directed toward the operator (see FIG. 1). Further, the display 103 is a display for a customer, and its display surface is directed toward the customer (see FIG. 1). In this regard, as the display 102 is configured by a touch panel, all keys of the keyboard 101 or a part thereof may be realized on the touch panel.

The printer 104 is a printer such as a thermal printer, and prints a receipt or a log under the control of the CPU 111. The drawer 105 is a cash drawer which accommodates cash or the like, and is opened and closed under the control of the CPU 111.

Further, the storage section 114 and a communication I/F 115 are connected to the CPU 111 through a variety of input/output circuits (not shown).

The storage section 114 is a storage medium such as an HDD (Hard Disk Drive) or a flash memory, and stores a program 114a capable of being executed by the CPU 111 or a variety of files. As an example of the program stored in the storage section 114, a program for a settlement process may be used. Further, as an example of the file stored in the storage section 114, a PLU (Price Look Up) file 114b may be used.

The PLU file 114b is a file for retaining information relating to each product. Specifically, a category code indicating the type of the product or a product code which is uniquely allocated to each product, and a record in which a name and a price of the product are matched, are retained in the PLU file 114b, for each product sold in a store.

The communication I/F (interface) 115 is an interface for performing data communication with the product code reader 200. The CPU 111 transmits or receives various data to or from the product code reader 200 through the communication I/F 115.

Further, the CPU 111 of the POS terminal 100 operates a settlement processing section 121, in cooperation with the program stored in the ROM 112 or the storage section 114, as shown in FIG. 2.

The settlement processing section 121 performs the settlement process relating to settlement for the product. Specifically, when an input of the product code is received from the product code reader 200, the settlement processing section 121 reads a record corresponding to the product code from the PLU file 114b, and outputs the result to the display 102 and the display 103 for display. Further, the settlement processing section 121 performs sale registration for the record of each product read from the PLU file 114b, on the basis of the number of product units sold. Here, the sale registration is for retaining the record of each product read from the PLU file 114b in the RAM 113 in relation to the number of purchases of the product.

Further, if the total price (purchase price) of all products is calculated from the price of each product sale-registered and the number of sales according to input of the “sum” key of the keyboard 101, and if payment of the total price is confirmed, the settlement processing section 121 performs a receipt output based on the payment method (cash or credit) through the printer 104.

Next, the configuration of the product code reader 200 will be described. As shown in FIG. 2, the product code reader 200 includes the CPU 211, the ROM 212 and the RAM 213.

The CPU 211 causes a variety of programs stored in the ROM 212 to be executed, to thereby control the product code reader 200. The ROM 212 stores a program for performing a basic operation. The RAM 213 is a main storage device of the product code reader 200, and functions as a work area of the CPU 211.

Further, the keyboard 202, the display 203, and the display 204 are connected to the CPU 211, through a variety of input/output circuits (not shown).

The keyboard 202 is an input device which notifies the CPU 211 of key information input from the operator who operates the product code reader 200. The keyboard 202 is used for input of the number of product units sold, input of the product code of a product the barcode of which is difficult to read, or the like.

The display 203 and the display 204 include a display device such as an LCD, and display a variety of information on the basis of an instruction of the CPU 211. Here, the display 203 is a display for an operator who operates the product code reader 200, and its display surface is directed toward the operator (see FIG. 1). Further, the display 204 is a display for a customer, and its display surface is directed toward the customer (see FIG. 1). As the display 203 is configured by a touch panel, all keys of the keyboard 202 or a part thereof may be realized on the touch panel.

Further, an information I/F 214, an imaging section 215 and a storage section 216 are connected to the CPU 211, through a variety of input/output circuits (not shown).

The communication I/F 214 is an interface for performing data communication with the POS terminal 100. The CPU 211 transmits or receives various data to or from the POS terminal 100 through the communication I/F 214. The imaging section 215 is an image sensor such as a CCD (Charge Coupled Device) or a CMOS (Complementary Metal Oxide Semiconductor), and is installed in the reading window 201 shown in FIG. 1. Further, the imaging section 215 starts imaging under the control of the CPU 211.

The storage section 216 is a recording medium such as an HDD or a flash memory, and stores a program 216a capable of being executed by the CPU 211 or a variety of files. Here, as an example of the program 216a stored in the storing section 216, a program for controlling the imaging section 215, a program for code symbol reading, a program for image or character recognition such as OCR (Optical Character Recognition) or pattern matching, or the like may be used. Further, as an example of the file stored in the storage section 216, a template file 216b for pattern recognition used for detecting a specific item or the like may be used.

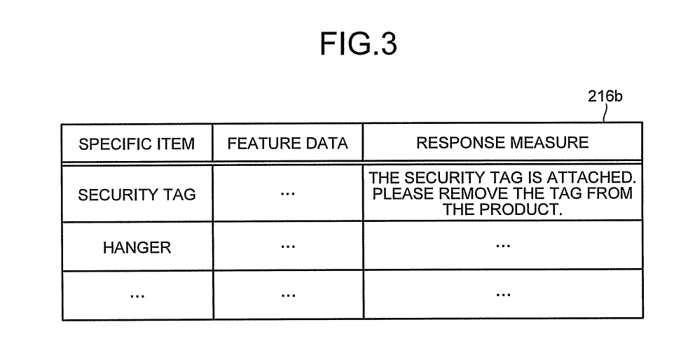

FIG. 3 is a diagram schematically illustrating an example of the template file 216b. As shown in the figure, the template file 216b manages a name (type) of the specific item, feature data indicating a feature of the specific item, and a response measure to be matched.

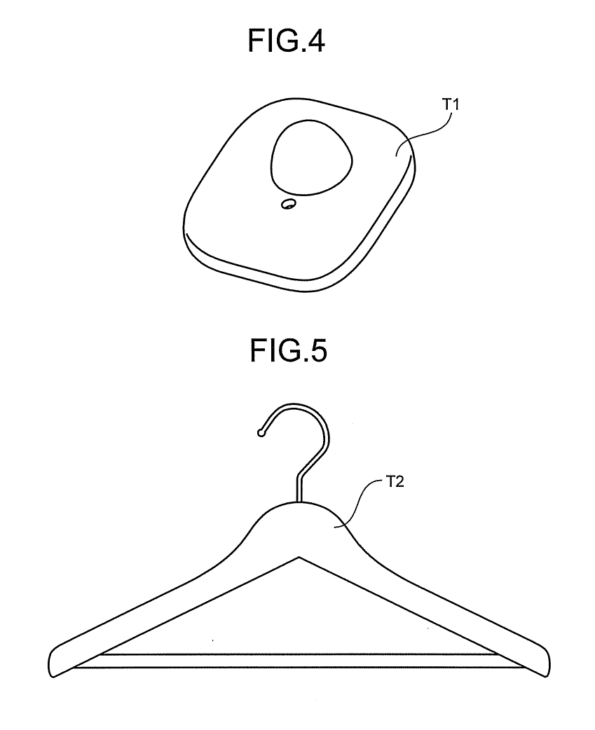

Here, the feature data is data which defines an appearance feature (shape or the like) of the various specific items, and is used in pattern matching with the image data imaged by the imaging section 215. For example, when the specific item is a “security tag”, as shown in FIG. 4, data (image data or the like) indicating an appearance feature of the security tag, such as a shape of a security tag T1 used in the store, is used as the feature data. Further, when the specific item is a “hanger”, as shown in FIG. 5, data (image data or the like) indicating an appearance feature of the hanger, such as a shape of a hanger T2 used in the store, is used as the feature data.

Further, the response measure includes information indicating a response measure of the operator at the time when each specific item is detected. For example, a character string (message) which is “the security tag is attached, please remove the tag from the product” corresponds to the response measure in the specific item “security tag”.

Next, the characteristic functional sections included in the product code reader 200 will be described. The CPU 211 operates an image data importing section 221, a code reading section 222, a specific item detecting section 223, a notifying processing section 224 and an information output section 225, in cooperation with a program stored in the ROM 212 or the storage section 216, as shown in FIG. 2.

The image data importing section 221 outputs an imaging ON signal to the imaging section 215, to thereby allow the imaging section 215 to start the imaging operation. The image data importing section 221 imports the image data imaged by the imaging section 215 and then stores the result in the RAM 213.

The code reading section 222 detects an image of a barcode affixed to the product from the image data stored in the RAM 213 by the image data importing section 221, and then reads a product code from the detected barcode. Specifically, the code reading section 222 binarizes image data of one frame stored in the RAM 213, and detects whether a data region relating to the barcode is present in the binarized data. When the data region relating to the barcode is detected, the code reading section 222 decodes the barcode and reads the decoded data as a product code of the product G. Further, the code reading section 222 stores the read product code in the RAM 213.

The specific item detecting section 223 performs a specific item detection process of detecting an image of a specific item from the image data stored in the RAM 213 by the image data importing section 221. Specifically, by performing character recognition or pattern matching on the basis of the feature data of each specific item retained in the template file 216b, the specific item detecting section 223 determines whether the image of the specific item is included in the image data. Further, when it is determined that the image of the specific item is included, the specific item detecting section 223 determines that the specific item is detected from the image data. Known techniques are used for the character recognition or pattern matching process.

When the specific item detecting section 223 detects the image of the specific item from the image data, the notifying processing section 224 reads a response measure corresponding to the specific item from the template file 216b, and displays the result on the operator display 203, to thereby notify the operator of the product code reader 200 of the response measure.

Further, the information output section 225 transmits (outputs) the product code read by the code reading section 222 to the POS terminal 100 through the communication I/F 214.

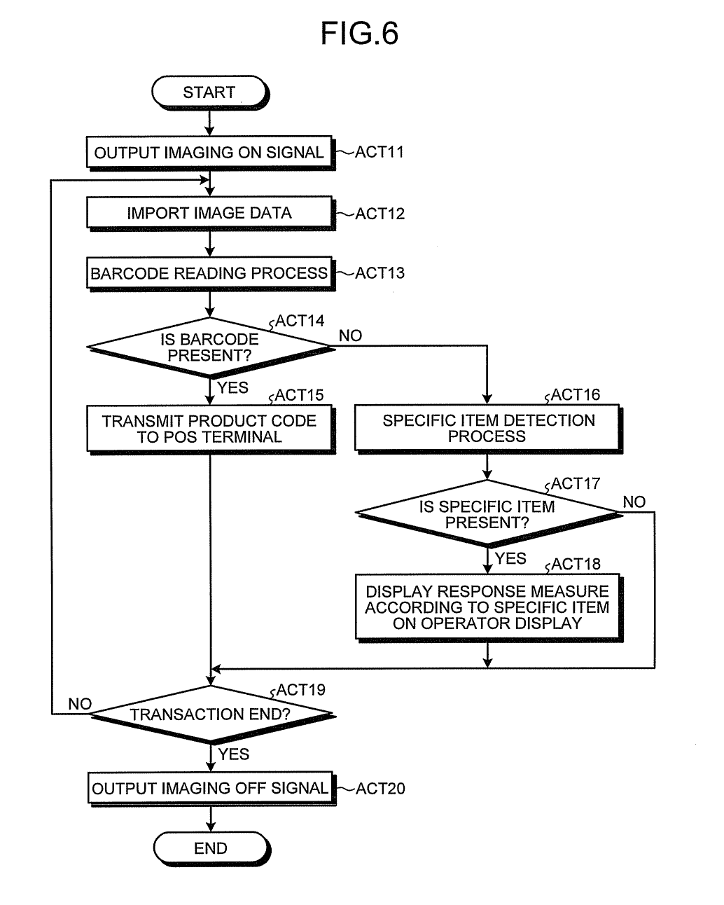

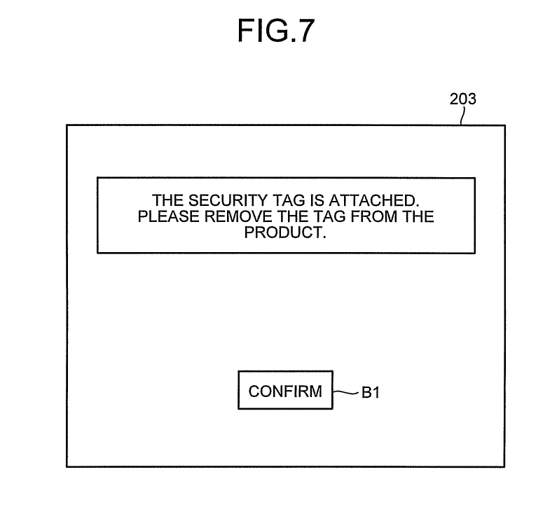

Hereinafter, the operation of the checkout system according to this embodiment will be described with reference to FIGS. 6 and 7. Here, FIG. 6 is a flowchart illustrating a routine of an information output process performed by the product code reader 200.

If transaction start is instructed by a signal from the POS terminal 100, the CPU 211 of the product code reader 200 starts the information output process. The image data importing section 221 outputs an imaging ON signal to the imaging section 215, and starts the imaging operation through the imaging section 215 (ACT 11). The image data importing section 221 imports the image data imaged by the imaging section 215 to the RAM 213 (ACT 12).

Subsequently, when the barcode reading process is started (ACT 13), the code reading section 222 determines whether the barcode is detected from the image data imported to the RAM 213 (ACT 14). Here, if the code reading section 222 detects the barcode (Yes in ACT 14), the information output section 225 outputs the product code stored in the RAM 213 by the code reading section 222 to the POS terminal 100 through the communication I/F 214 (ACT 15), and then the routine proceeds to ACT 19. When the number of product units sold is input through the keyboard 202, the information output section 225 outputs the number of product units sold and the product code.

On the other hand, in ACT 14, if the barcode is not detected (No in ACT 14), the specific item detecting section 223 starts the specific item detection process (ACT 16), and determines whether the specific item is detected from the image data imported to the RAM 213 (ACT 17).

Here, if the specific item detecting section 223 detects the specific item from the image data (Yes in ACT 17), the notifying processing section 224 reads the response measure corresponding to the specific item from the template file 216b, displays the result on the operator display 203 (ACT 18), and then the routine proceeds to ACT 19. If the specific item is not detected from the image data (No in ACT 17), the routine directly proceeds to ACT 19.

Here, FIG. 7 is a diagram illustrating an example of a display screen displayed in ACT 18. In the figure, an example in which the “security tag” is detected as the specific item is shown, and a message which is “security tag is attached, please remove the tag from the product” is displayed as a response measure according to the specific item. The operator of the product code reader 200 can easily recognize that the specific item is attached to the product G on the basis of the message displayed on the display 203, and can easily confirm the response measure.

A selection button B1 in FIG. 7 is used for confirmation of the display screen. If the specific item detecting section 223 detects that the selection button B1 is operated by the operator of the product code reader 200 through the keyboard 202, the routine proceeds to the subsequent process (ACT 19).

In ACT 19, the CPU 211 determines whether transaction end is instructed by a signal from the POS terminal 100 (ACT 19). If the transaction end is not instructed (No in ACT 19), the routine returns to ACT 12 again. Then, the operations of the ACTs 12 to 19 are repeated until the transaction end is instructed. Further, if the transaction end is instructed (Yes in ACT 19), the image data importing section 221 outputs an imaging OFF signal to the imaging section 215, to thereby stop the imaging operation in the imaging section 215 (ACT 20). Then, this process is terminated.

As described above, according to the product code reader 200 according to this embodiment, by detecting the specific item from the image data of the product imaged by the imaging section 215, it is determined whether the specific item is attached to the product. In this way, by automatically performing the detection of the specific item from the image data imaged by the imaging section 215, it is possible to more reliably perform the detection of the specific item attached to the product.

Further, according to the product code reader 200 according to this embodiment, when the specific item is detected from the image data, the response measure according to the specific item is displayed on the operator display 203. In this way, as the response measure according to the specific item is indicated to the operator of the product code reader 200, it is possible to prevent of an oversight of the operator, thereby enhancing a service level.

Thus, in the above-described process, when the barcode is not detected in the barcode reading process of ACT 13, the specific item recognition process of ACT 16 is performed, but the present embodiment is not limitative. For example, the specific item recognition process may be performed in parallel with the barcode reading process. Alternatively, the specific item recognition process may be performed regardless of the result of the barcode reading process.

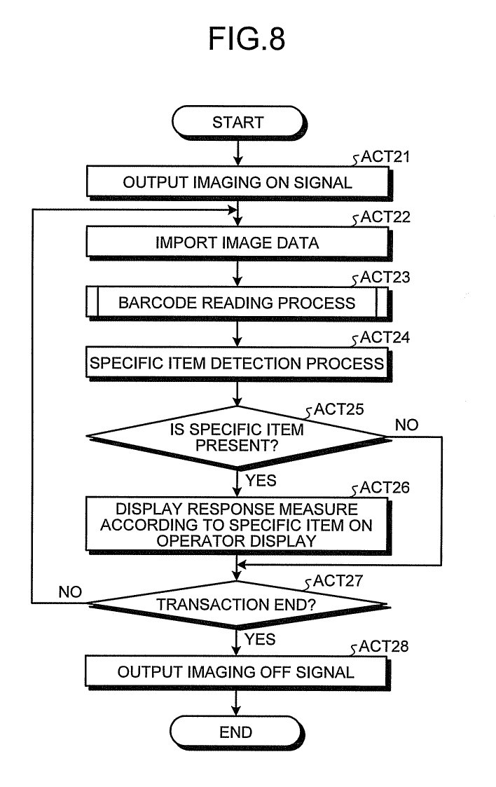

Here, FIG. 8 is a flowchart illustrating another routine of an information output process at the time when the specific item recognition process is performed regardless of the result of the barcode reading process. In FIG. 8, ACTs 21 and 22 are the same as in the above-described ACTs 11 and 12. ACT 23 is a sub routine corresponding to the operations of the above-described ACTs 13 to 15. In ACT 23, the routine proceeds to ACT 24, regardless of the presence or absence of the barcode detection.

In ACT 24, the specific item detecting section 223 starts the specific item detection process (ACT 24), and determines whether the specific item is detected from the image data imported to the RAM 213 (ACT 25).

Here, if the specific item detecting section 223 detects the specific item from the image data (Yes in ACT 25), the notifying processing section 224 reads the response measure corresponding to the specific item from the template file 216b, displays the result on the operator display 203 (ACT 26), and then the routine proceeds to ACT 27. If the specific item is not detected from the image data (No in ACT 25), the routine directly proceeds to Act 27.

In ACT 27, the CPU 211 determines whether transaction end is instructed by a signal from the POS terminal 100 (ACT 27). If the transaction end is not instructed (No in ACT 27), the routine returns to ACT 21 again. Then, the operations of the ACTs 21 to 27 are repeated until the transaction end is instructed. Further, if the transaction end is instructed (Yes in ACT 27), the image data importing section 221 outputs an imaging OFF signal to the imaging section 215, to thereby stop the imaging operation by the imaging section 215 (ACT 28). Then, this process is terminated.

As described above, when the information output process shown in FIG. 8 is performed, it is also possible to achieve the same effect as in the product code reader 200.

In the information output process in FIGS. 6 and 8, the response measure according to the specific item is displayed whenever the specific item is recognized, but the present embodiment is not limitative. For example, in a state where the detection result of the specific item is retained in RAM 213, the response measures of the respective specific items may be displayed at a time or sequentially at a predetermined timing such as transaction end. Further, in a state where the detection result of the specific item is retained in RAM 213 together with the image data in which the specific item is detected, the response measures of respective specific items may be displayed together with the corresponding image data at a time or sequentially at a predetermined timing such as transaction end.

### MODIFIED EXAMPLES

Next, modified examples of the above-described embodiment will be described. The same reference numerals are given to the same components as in the above-described embodiment, and description thereof will be omitted.

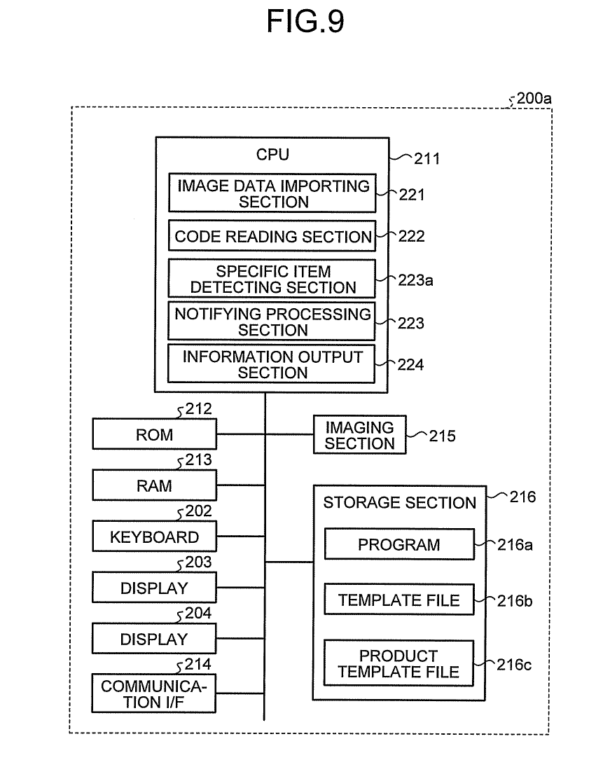

FIG. 9 is a block diagram illustrating a configuration of a product code reader 200a according to this modified example. As shown in the figure, a storage section 216 of the product code reader 200a is different from the product code reader 200 in that a product template file 216c in addition to a program 216a and a template file 216b is stored. Further, a CPU 211 of the product code reader 200a operates an image data importing section 221, a code reading section 222, a specific item detecting section 223a, a notifying processing section 224 and an information output section 225, in cooperation with a program stored in a ROM 212 or the storage section 216.

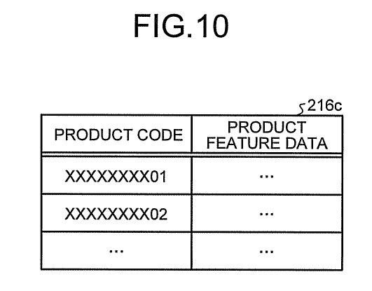

FIG. 10 is a diagram schematically illustrating an example of the product template file 216c. As shown in the figure, the product template file 216c manages a product code of each product and product feature data indicating a feature of the product to be matched.

Here, the product feature data is image data or the like which defines an appearance feature (shape or the like) of each product, and is used in pattern matching with the image data imaged by the imaging section 215. The shape or feature of the product defined in the product feature data may correspond to the entire product or a part thereof.

A specific item detecting section 223a performs a specific item detection process of detecting an image of a specific item from the image data stored in the RAM 213 by the image data importing section 221.

Specifically, the specific item detecting section 223a reads product feature data corresponding to the product code read by the code reading section 222 from the product template file 216c, performs character recognition or pattern matching on the basis of the corresponding product feature data, and thus determines whether an image different from the image of the product corresponding to the product code is included in the image data. If it is determined that the different image is included in the image data, the specific item detecting section 223a performs character recognition or pattern matching on the basis of the feature data of each specific item retained in the template file 216b, and thus determines whether the different image indicates the specific item. Further, if it is determined that the different image is the specific item image, the specific item detecting section 223a determines that the specific item is detected from the image data.

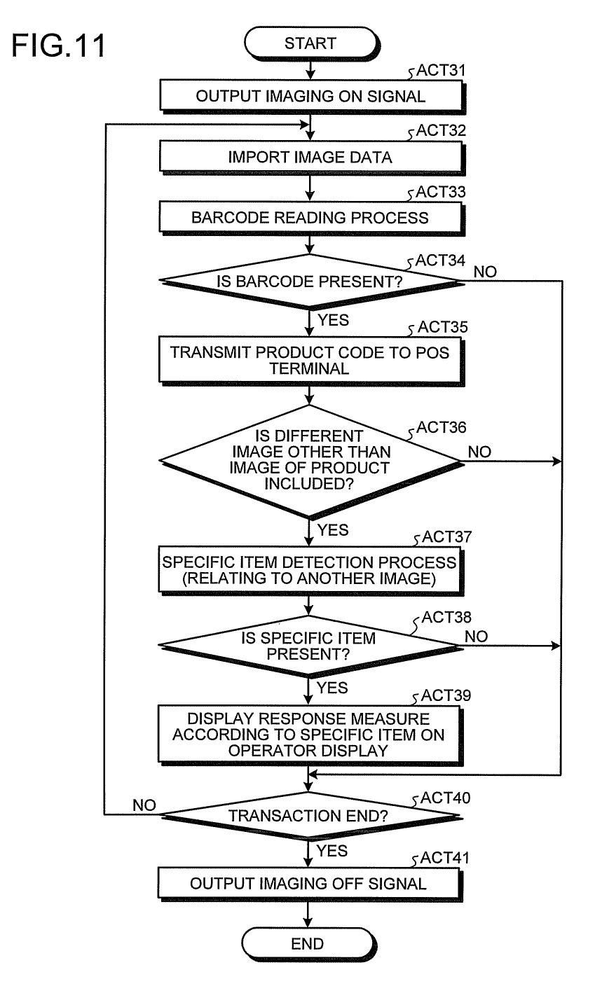

Hereinafter, an operation of a checkout system in this modified example will be described with reference to FIG. 11. Here, FIG. 11 is a flowchart illustrating a routine of an information output process performed by the product code reader 200a. Since operations of ACTs 31 to 33 are the same as in the above-described ACTs 11 to 13, description thereof will be omitted.

The code reading section 222 determines whether a barcode is detected from the image data imported to the RAM 213 (ACT 34). Here, if the barcode is not detected (No in ACT 34), the routine directly proceeds to ACT 40.

In ACT 34, if the code reading section 222 detects the barcode (ACT 34), the information output section 225 outputs the product code stored in the RAM 213 by the code reading section 222 to the POS terminal 100 through the communication I/F 214 (ACT 35).

Subsequently, if the product feature data corresponding to the product code stored in the RAM 213 by the code reading section 222 is read from the product template file 216c, the feature item detecting section 223a determines whether the image different from the image of the product corresponding to the product code is included in the image data on the basis of the product feature data (ACT 36).

In ACT 36, if it is determined that the different image is not included in the image data (No in ACT 36), the routine proceeds to ACT 40. On the other hand, if it is determined in ACT 36 that the different image is included in the image data (Yes in ACT 36), the feature item detecting section 223a starts a specific item detection process (ACT 37), and determines whether the specific item is detected from the image data imported to the RAM 213 (ACT 38).

Here, if the specific item detecting section 223 detects the specific item from the image data (different image) (Yes in ACT 38), the notifying processing section 224 reads the response measure corresponding to the specific item from the template file 216b, displays the result on the operator display 203 (ACT 39), and then the routine proceeds to ACT 40. If the specific item is not detected from the image data (different image) (No in ACT 38), the routine directly proceeds to ACT 40.

In ACT 40, the CPU 211 determines whether transaction end is instructed by a signal from the POS terminal 100 (ACT 40). If the transaction end is not instructed (No in ACT 40), the routine returns to ACT 32. Then, the operations of the ACTs 32 to 40 are repeated until the transaction end is instructed. Further, if the transaction end is instructed (Yes in ACT 40), the image data importing section 221 outputs an imaging OFF signal to the imaging section 215, to thereby stop the imaging operation in the imaging section 215 (ACT 41). Then, this process is terminated.

As described above, according to the product code reader 200a according to this modified example, by detecting the different image other than the image of the product corresponding to the product code read by the code reading section 222 from the image data of the product imaged by the imaging section 215, and by detecting the specific item from the different image, it is determined whether the specific item is attached to the product. In this way, by detecting the specific item from the different image other than the product image, it is possible to perform a correct process for the product in a case where the product has the same shape as the specific item (for example, a case where the product is the hanger shown in FIG. 5).

Further, according to the product code reader 200a according to this modified example, when the specific item is detected from the image data, the response measure according to the specific item is displayed on the operator display 203. In this way, as the response measure according to the specific item is notified to the operator of the product code reader 200a, it is possible to prevent an oversight of the operator, thereby enhancing a service level.

Hereinbefore, the embodiments have been described, but the embodiments are not limitative. A variety of modifications, substitutions, additions or the like are possible in a range without departing from the scope of the invention.

For example, in the above embodiments, when the specific item is detected, the message which instructs removal of the specific item is output, but in the case of the security tag, function invalidation such as attachment of a radio wave blocking seal may be instructed in removal of the tag from the product.

Further, in the above embodiments, the PLU file 114b is stored in the POS terminal 100, but the embodiments are not limitative. For example, the PLU file 114b may be stored in an external device which the POS terminal 100 can access.

Further, in the above embodiments, the example of the checkout system is described, but the embodiments are not limitative. For example, the embodiments may be applied to a self-checkout terminal in which a client can read a product code and can perform a settlement process.

Further, the programs executed by the POS terminal 100 and the product code reader 200 may be recorded and provided in a computer-readable recording medium such as a CD-ROM (Compact Disc Read Only Memory), a flexible disc (FD), a CD-R (Compact Disc Recordable), or a DVD (Digital Versatile Disc) as a file of a format which is capable of being installed or executed.

Further, the programs executed by the POS terminal 100 and the product code reader 200 may be stored in a computer connected with a network such as the Internet, and then may be downloaded and provided through the network. Further, the programs executed by the POS terminal 100 and the product code reader 200 may be provided or distributed through a network such as the Internet.

What is claimed is:

1. A product code reader comprising:
an image importing section which imports an image imaged by an imaging section;
a code symbol detecting section which detects a code symbol affixed to a product, from a product image imported by the image importing section;
a code reading section which reads code information retained in the code symbol, from the code symbol detected by the code symbol detecting section; and
a specific item detecting section which detects a predetermined article attached to the product as a specific item, from the product image imported by the image importing section.

2. The reader according to claim 1,
wherein the specific item detecting section detects the specific item from the image imported by the image importing section, on the basis of a template file which defines an appearance feature of the specific item for each specific item.

3. The reader according to claim 2,
wherein the specific item detecting section detects an image different from the product image corresponding to the code information read by the code reading section from the product image imported by the image importing section on the basis of a product template file which correspondingly defines the code information for each product and the appearance feature of the product, and detects the specific item from the different image.

4. The reader according to claim 1, further comprising a notifying section which notifies a response measure according to the specific item when the specific item is detected by the specific item detecting section.

5. The reader according to claim 4,
wherein the notifying section displays the response measure according to the specific item on an operator display.

6. The reader according to claim 4,
wherein the notifying section notifies the response measure according to the specific item whenever the specific item detecting section detects the specific item.

7. The reader according to claim 4,
wherein the notifying section notifies the response measure according to each specific item detected by the specific item detecting section, at a time or sequentially at a predetermined timing.

8. The reader according to claim 4,
wherein the notifying section notifies the response measure relating to each specific item detected by the specific item detecting section, on the basis of a response measure file which defines a response measure relating to the specific item for each specific item.

9. The reader according to claim 1, further comprising a transmitting section which transmits the code information read by the code reading section to an external device.

10. A product code reading method, comprising:
importing an image imaged by an imaging section;
detecting a code symbol affixed to a product, from a product image imported in the importing of the image;
reading code information retained in the code symbol, from the code symbol detected in the detecting of the code symbol; and
detecting a predetermined article attached to the product as a specific item, from the product image imported in the importing of the image.
